(19) United States
(12) Patent Application Publication
(10) Pub. No.: US 2017/0270376 A1
(43) Pub. Date: Sep. 21, 2017

(54) AUTOMOTIVE COLLISION AVOIDANCE SENSOR SYSTEM

(71) Applicant: OLALEYE A. AINA, BALTIMORE, MD (US)

(72) Inventor: OLALEYE A. AINA, BALTIMORE, MD (US)

(21) Appl. No.: 15/615,780

(22) Filed: Jun. 6, 2017

Related U.S. Application Data
(63) Continuation-in-part of application No. 14/218,607, filed on Mar. 18, 2014, now Pat. No. 9,671,489.

(51) Int. Cl. G06K 9/00; G01S 7/48

(52) U.S. Cl. CPC G06K 9/00805; G01S 7/4804; B60T 2201/022; B60T 2210/32; G01S 2013/9375

(57) ABSTRACT

In an automotive collision avoidance sensor system installed at both the fore and aft of a vehicle, there is provided an output lens, an input lens, and a transmit laser. The transmit laser is adapted to transmit a pulsed beam through the output lens to impact roadway, surrounding vehicles or objects fore, aft, port and starboard of the vehicle, with return signals from the roadway, surrounding vehicles or objects reflecting off the input lens. A sensor of the system adapted collects the return signals from the input lens to convert them into output voltages and signals, and has a data processor configured to analyze the output voltages and signals so as to calculate real-time 3-dimensional situation awareness measurements and safety metrics which are constantly measured and updated to prevent possible collision.

### CROSS-REFERENCE TO RELATED APPLICATIONS

The present application claims priority under 35 U.S.C. §120 to U.S. patent application Ser. No. 14/218,607, filed Mar. 18, 2014 to Aina et al. (pending/allowed) which is herein incorporated by reference in its entirety.

### BACKGROUND

Field

The example embodiments in general are directed to an automotive collision avoidance sensor system.

Related Art

Lasers or other forms of coherent electromagnetic radiation (ER) today have numerous applications, such as applications for marking and guiding munitions, vehicles, determining distance (ranging), navigating, surveying, remote sensing, highlighting an object and so on. In response, laser warning receiver (LWR) systems have become important to detect and process laser emissions. Typically, a LWR is a passive system that detects incoming laser emissions and processes the incoming laser emissions for various parameters, such as range of the origin or source of the laser emissions to the LWR system, angle of arrival of the laser emissions, spectral content, etc. For example, it is common for military vehicles, such as planes, helicopters, ships, etc., to be equipped with a LWR system. LWR systems may also be used in civilian or commercial settings, such as for vehicle safety, mass transit, etc.

Currently, the known LWR's are limited in sensitivity, range, spectral coverage (e.g., range of wavelengths detectible by the LWR system), angular coverage, operating temperature, resolution, etc. Moreover, current LWR devices are large and/or bulky and consume large amounts of power. This makes the known LWR systems unsuitable for many applications in which they would otherwise be useful. Furthermore, the known LWR's are prone to false alarms due to ambient light and/or other sources of optical emissions, which are common in the environment.

Applicant described a solution to the above limitations in their co-pending '607 application, presenting an electromagnetic or laser warning sensor of an optical detection system and system thereof. In general, the system includes a Fresnel lens coupled to an array of photodetectors having a pixel pitch which enabled an angular coverage of up to 360°.

In operation, the Fresnel lens collects incident optical signals and focuses the same onto the array, where the optical signals into electrical outputs analyzed by the optical detection system to determine, for each optical signal, an incident angle of arrival of thereof, and a range of a source of the optical signal to the sensor that is determined from the calculated angle of arrival. The electrical outputs were further analyzed to minimize a false alarm rate by discriminating each optical signal spectrally to calculate a wavelength thereof, so as to distinguish whether an incident optical signal is from a narrowband laser source operating at a single wavelength or from a broadband light source operating at a continuum of wavelengths.

Applicant has discovered that their sensor technology, with slight variations, is applicable to automotive collision avoidance technologies, for both driver and driverless cars. Currently, it has been observed that smart/intelligent cars (such as those of UBER® or GOOGLE®) are employing LiDAR. These are cumbersome and expensive ($65,000) systems, typically sitting 4 feet above the driver line of sight, and utilizing several rotating lenses in an effort to build a picture of the 3D environment around the car. The sensitivity of these sensors is also poor, particularly degrading in poor weather/visibility conditions (fog, snow, rain, etc.). Moreover, these current LiDAR systems are limiting in terms of their actual capability, and can only see a swath or narrow beam angle at a time. So instead of a complete 360 degree view, a series of cylindrical views are fed into a computation engine, thus it is a very computation-intensive system. Therefore, these system cannot provide the 3D picture at every instant as can the human brain, being limited by the frame rate (typically 10-60 Hz) which is way too slow a reaction/refresh time.

What is needed is a collision avoidance sensor system providing a lower cost, lower power and less computationally intensive solution, particularly one which is more sensitive as well as requiring less power both in normal and obscured conditions.

### SUMMARY

An example embodiment is directed to an automotive collision avoidance sensor system installed at both the fore and aft of a vehicle, which includes an output lens, an input lens, and a transmit laser. The transmit laser is adapted to transmit a pulsed beam through the output lens to impact roadway, surrounding vehicles or objects fore, aft, port and starboard of the vehicle, with return signals from the roadway, surrounding vehicles or objects reflecting off the input lens. A sensor of the system adapted collects the return signals from the input lens to convert them into output voltages and signals, and has a data processor configured to analyze the output voltages and signals so as to calculate real-time 3-dimensional situation awareness measurements and safety metrics which are constantly measured and updated to prevent possible collision.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 shows a simplified block diagram of Applicants laser warning receiver (LWR) system of their '607 application.

FIG. 2 shows a more detailed block diagram as shown in FIG. 1.

FIG. 3 shows implementation of the block diagram of FIG. 2 in more detail.

FIG. 4 shows an alternative circuit diagram of system 100 from Applicant's '607 application.

FIG. 5 shows an exemplary resistive load circuit interface that may be employed in some embodiments.

FIG. 6 shows a more detailed block diagram of the sensor.

FIG. 7 is directed to a 2D optics and detector array.

FIG. 8 shows an image of an exemplary 2D detector array.

FIG. 9 conceptually illustrates how laser emissions and its angle of arrival are captured by the 2D detector array in the sensor.

FIG. 10 illustrates an algorithm for angular determination of an optical signal, such as a laser, using the 2D array in a sensor.

FIG. 11 shows one example of how data from the detector 106 may be processed to determine angular information of laser emissions.

FIG. 12 shows exemplary 1D detector arrays.

FIG. 13 conceptually illustrates how laser emissions are distinguished from other types of optical information by the 1D detector array.

FIG. 14 is a general process flow for explaining the methodology for detecting threats.

FIG. 15 is a more detailed process flow.

FIG. 16 is a process flow for laser emission detection.

FIG. 17 illustrates how the system sets a detection threshold.

FIG. 18 is a picture of an automotive collision avoidance sensor system mounted on an automobile, according to the example embodiments.

FIG. 19 is a block diagram of the sensor system of FIG. 18.

FIG. 20 is a general electro-optical flow diagram to explain functionality of the sensor system.

### DETAILED DESCRIPTION

Before delving into Applicant's novel automotive collision avoidance system, Applicants provides the background of their electromagnetic or laser warning sensor as described in the co-pending '607 application. In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

In Applicant's co-pending '607 application, which forms the basis for this new subject matter, there is described a laser sensing system that has high angular resolution and is sensitive to a low laser powers. The sensing system is sensitive to a wide range of wavelengths, has up to a 360° angular coverage at the aperture of the system, and has high discrimination and angular resolution (e.g., the measure (in degrees or radians) of the system's ability to detect small details of the incident optical signal with high accuracy). In one embodiment, the laser sensing system has a near-zero false alarm rate ((FAR), e.g., the rate representing the time between false alarms with the system activated), nanowatt/cm2 optical sensitivity, and high detection probability. In addition, the system has spectral discrimination (e.g., the ability to determine the actual wavelength(s) of an optical signal incoming or incident to the system so as to discriminate a laser emission (narrowband and at a single wavelength) from a light emission (broadband signal with a spread of wavelengths) and or high angular resolution.

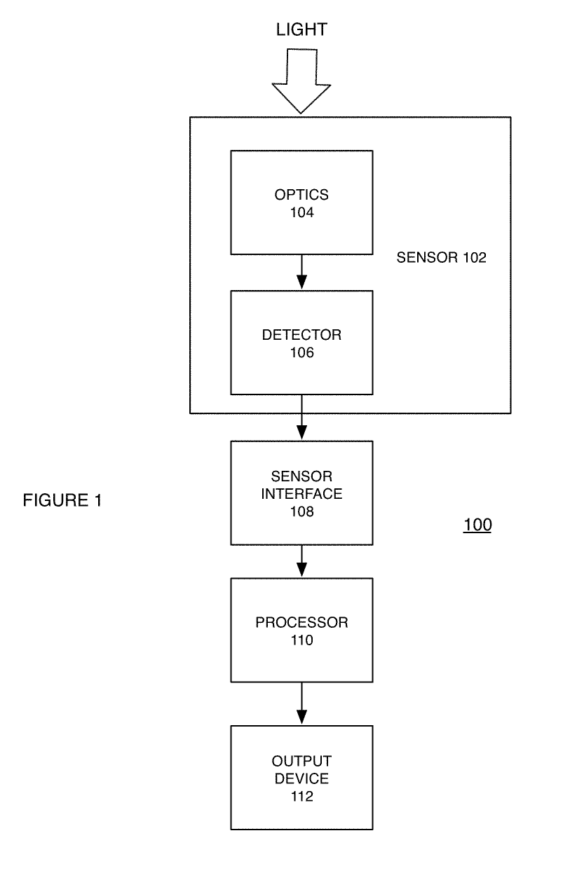

The following FIGS. 1-17 of Applicant's co-pending '607 application are provided as a backdrop to understanding Applicants' collision avoidance system and method. FIG. 1 shows a simplified block diagram of Applicant's laser warning receiver (LWR) system of their '607 application. In general, the system 100 may be deployed in numerous types of application. For example, the system 100 may be used as a laser warning receiver (LWR) system to detect a laser emission, e.g., from a threat or hostile source. LWR systems may be used in various settings, such as military operations, air travel, law enforcement, security, etc. Alternatively, the system 100 may be used in a civilian setting, such as for an automobile or train that uses laser to detect proximity to other vehicles or objects. For purposes of illustration, examples of the system 100 used as a LWR is provided in the present description. However, one skilled in the art will recognize how the embodiments may be implemented in a variety of settings.

TABLE 1 shows some exemplary performance specifications that may be achieved by Applicants LWR system.

TABLE 1
PERFORMANCE SPECS

Spec Description

| | |
|---|---|
| Spectral Coverage | 450 nm to 1550 nm |
| Sensitivity | 10 nW/cm² |
| False Alarm Rate | <1 per 1000 hours |
| Angular Coverage | 100° |
| Angular Resolution | 1-2° |
| Size, Power | 3.2 × 3.2 × 2 in (81 × 81 × 51 mm), 3 W |
| Operating Temperature | 0° C. to 60° C. |

As shown, the 100 may comprise a sensor 102, which further comprises optics 104 and a detector 106, a sensor interface 108, a processor 110, and an optional output device 112. The sensor 102 receives light and laser emissions and provides an output to indicate various parameters about the light and laser emissions. As noted, the sensor may comprise optics 104 and a detector 106.

The optics 104 are responsible for collecting the light and (if present) laser emissions and focusing the light onto the detector 106. In some embodiments, the optics 104 may be an optical package that comprises a lens and/or other types of ports. In one example, the optics 104 may be an optical package that comprises comprise a Fresnel lens and an optical grating. In another example, optics 104 may be an optical package that comprises a doublet Fresnel lens for 2D angle resolving detection (EFL 2.5 mm, FOV)>100° and a transmission grating and cylindrical lens (FL 5 mm, FOV)>100° focused on a one-dimensional linear array (1D array) for optical false alarm rejection.

The detector 106 is responsible for converting the light energy and received laser emissions into an electrical output. In one embodiment, the detector 106 may comprise an array of avalanche photodiodes (APDs) that are sensitive to various forms of light and laser emissions. Detector 106 may comprise multiple arrays of detectors to discriminate laser emissions and minimize/avoid false alarms. For example, the detector 106 may comprise a two dimensional (2D) array of APDs that form individual pixels and a one dimensional array (1D) array of APDs.

The angular coverage at the aperture of the 2D array depends directly on the pixel pitch, the number of pixels of the APD arrays and the optical configuration of the sensor 102. In an embodiment, the aperture of detector 106 in sensor 102 of system 100 has up to a 360° angular coverage. In this embodiment, the APD array layout may range from about 50-um pixel diameter and a pitch that ranges from about 150-um to 210-um pitch.

The sensor interface 108 is responsible for acquiring the signals from the detector 106 and converting them into useful output voltages and signals for analysis by the processor. In some embodiments, the sensor interface 108 comprises a readout integrated circuit (ROIC).

The processor 110 is responsible for analyzing the output of the sensor interface 108 and determining various parameters, such as angle of arrival of laser emissions, spectral content, range to source of laser emissions, etc. In one embodiment, processor 110 comprises a field programmable array (FPGA) module to process the detector data. For example, the processor 110 may be implemented based on an Opal Kelly XEM6010 Spartan-6 FPGA module. Alternatively, the processor 110 may be a microprocessor, such as a Rabbit Core RCM3400 microprocessor. One skilled in the art will recognize that various types of processors may be used in the embodiments.

The processor 110 may execute various algorithms and processes using executable program code and software. Data processing algorithms for detection and false alarm rejection and angle are further described below.

The processor 110 may also execute a software interface through a communications interface, such as RS-485 connector, a wireless network, etc. In some embodiments, processor 110 may execute software for detection and alarm declaration with or without real time data storage, for example, onto a storage card or other medium. The processor 110 may also be provided with GPS connectivity.

The output device 112 is an optional device of system 100 so that a user can interface with the system 100. For example, the output device 112 may be a speaker or display, a computer, a laptop, or other form of user interface device. The output device 112 may also comprise an interface to other computing systems, such as one or more communications ports or an application programming interface.

In one embodiment, the output device 112 is adaptable to various systems. For example, the output device 112 may employ one or more standard communications protocols, such as RS-485, as an output interface. The output device 112 may thus provide information about the threat and periodic system status updates.

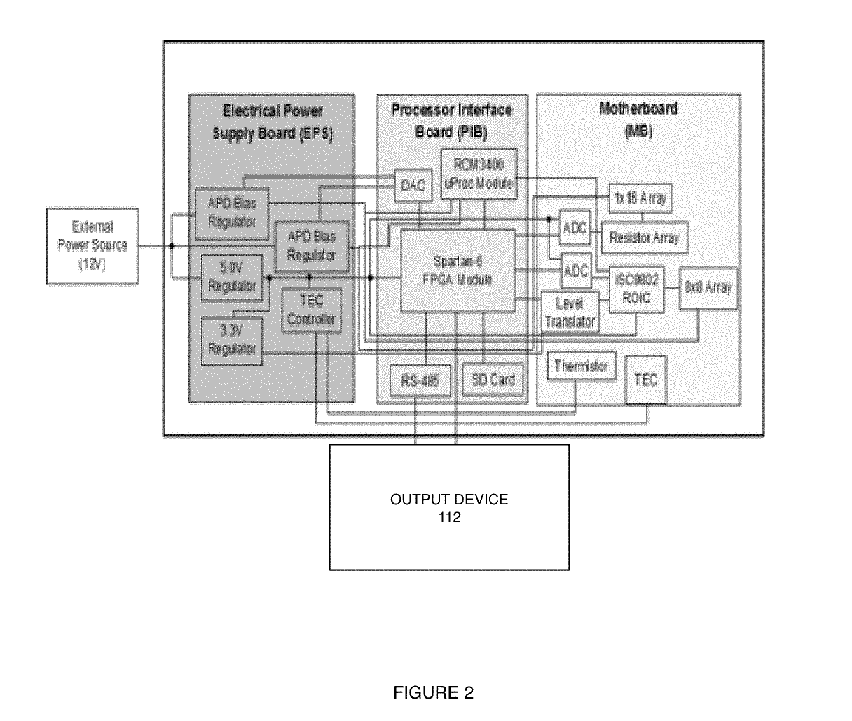

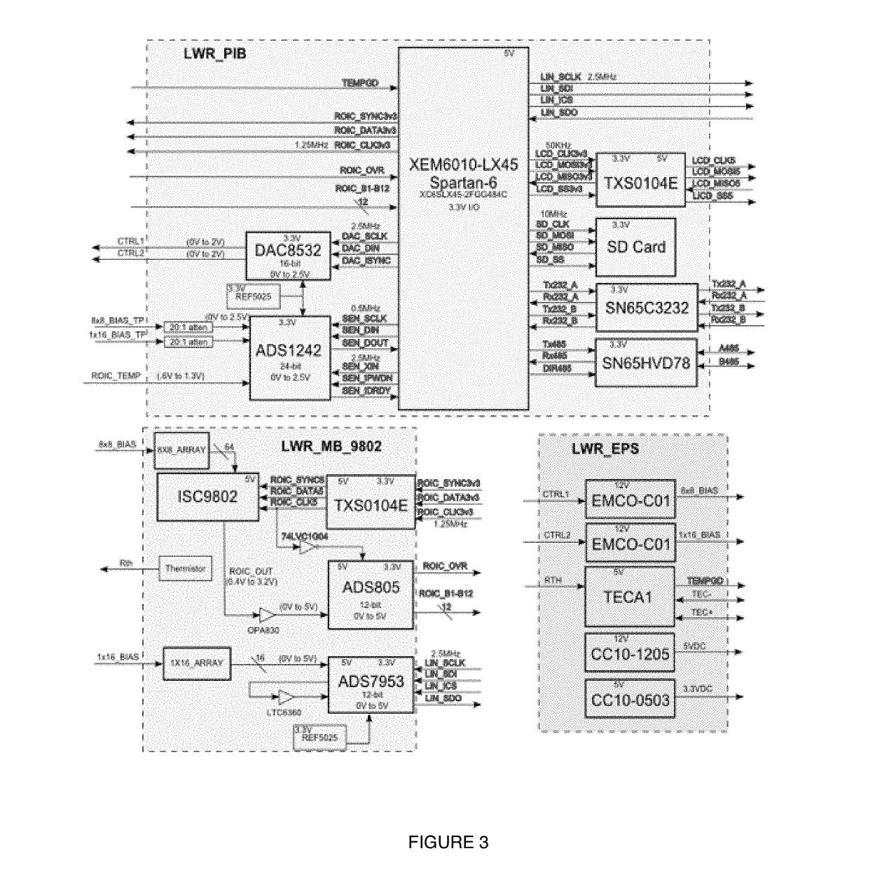

FIG. 2 shows a more detailed block diagram and FIG. 3 shows implementation of the block diagram of FIG. 2. The electrical power system board (EPS) regulates power to all components in the system. The processor interface board (PIB) implements the digital control logic and signal processing. The motherboard is a single board with ground plane to hold detectors and analog to digital conversion chips.

In FIG. 2, the detector board contains the APD array for detector 106 and sensor interface 106 as a ROIC, a motherboard containing the detector board and the processing and interface electronics. As also shown, the power components, such as bias regulators and power drivers, are located on a separate board, for example, to reduce noise in system 100. As shown, the motherboard includes the detector board, a thermoelectric cooler (TEC), a TEC driver and a thermistor for temperature stabilization of the LWR.

In one embodiment, the control and data processing components may employ an FPGA. For example, the Spartan-6 FPGA may be used to control the onboard chips (MUX, ADC, DAC, ROIC, RS485) and for processing the detector outputs and running the detection algorithms. Alternatively, a microprocessor may be used for onboard chip control and signal processing.

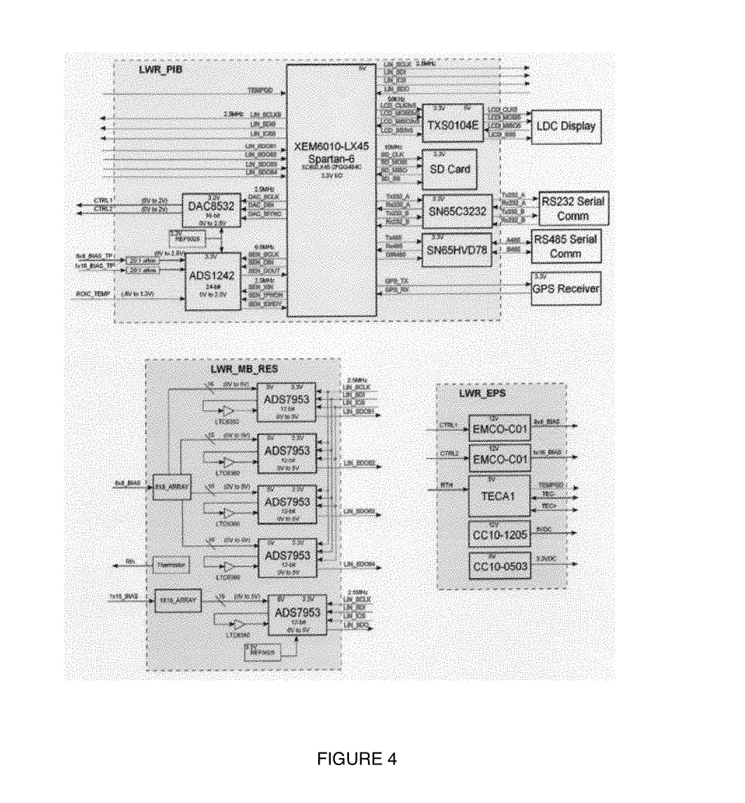

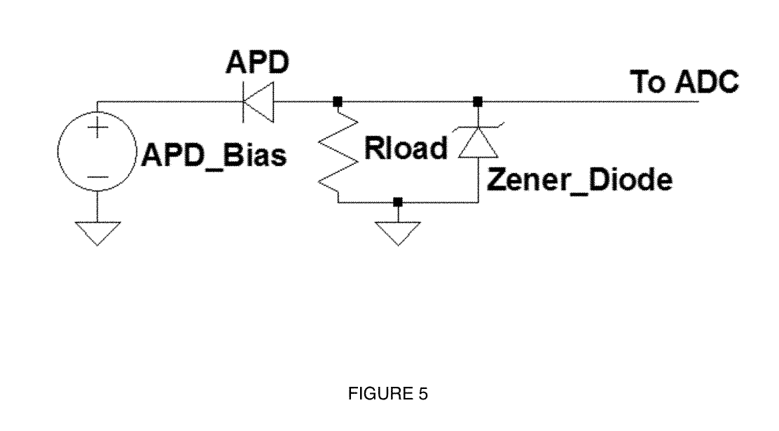

FIG. 4 shows an alternative circuit diagram of its system 100 that employs resistive load circuit interfaces that may be used to break the connection of an APD pixel if that pixel becomes defective. FIG. 5 shows an exemplary resistive load circuit interface that may be employed in some embodiments.

Resistors may be used in the sensor interface 108 to convert the photocurrent from the detector 104 into output voltages. This alternate approach may have better noise performance and speed. In this embodiment, all APD outputs from the detector 106 feed through a resistive load circuit (shown in FIG. 3) to convert optical current to voltage. Analog multiplexors may be used to switch between the detector outputs and connect to the ADCs on the motherboard.

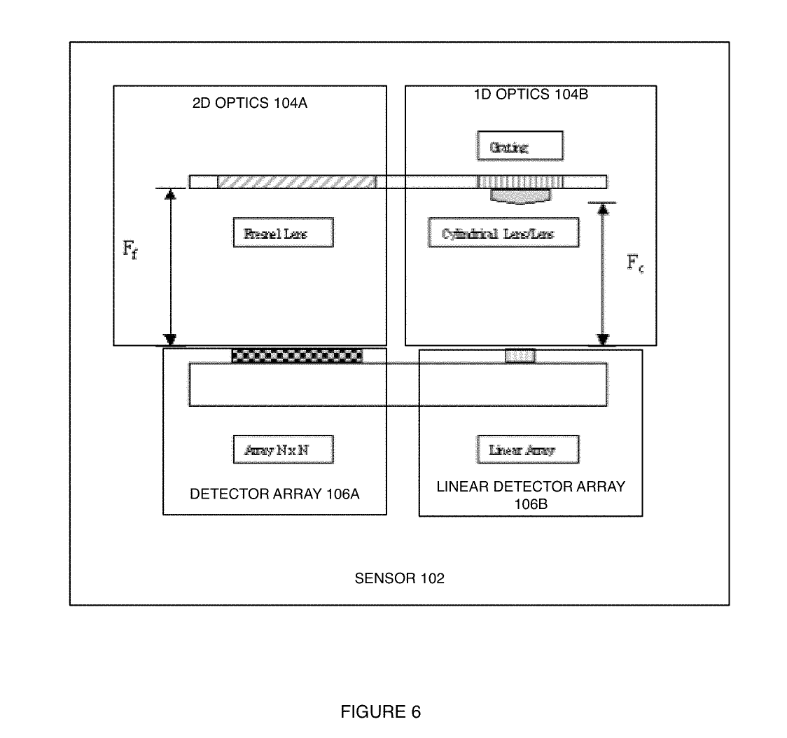

FIG. 6 shows a more detailed block diagram of the sensor. In this embodiment, the sensor 102 comprises an ultrasensitive wavelength dispersive photoreceiver array operating in the 450-1550 nm wavelength range. In some embodiments, the array(s) of sensor 102 can operate in a wavelength range between about 200 nm to 3000 nm. The photoreceiver array consists of specialized optics (2D optics 104A and 1D optics 104B) and the APD array (see 2D detector array 106A and linear 1D detector array 106B), and the sensor electrical interface 108 (not shown) is a read out integrated circuit (ROIC).

Angle of arrival detection is accomplished by using a Fresnel lens in optics 104A to focus incoming signals onto a pixel on an 8 by 8 APD detector array 106A. The angular discrimination can be determined by the pixel detecting the focused optical signal or the algorithms can be used to determine the angle of arrival.

Spectral discrimination and false alarm rejection is accomplished by using a transmission grating as part of 1D optics 104B and a cylindrical lens over a linear 1 by 16 APD detector array 106B (“1D detector array 106B”) and is used by the algorithms for false alarm rejection.

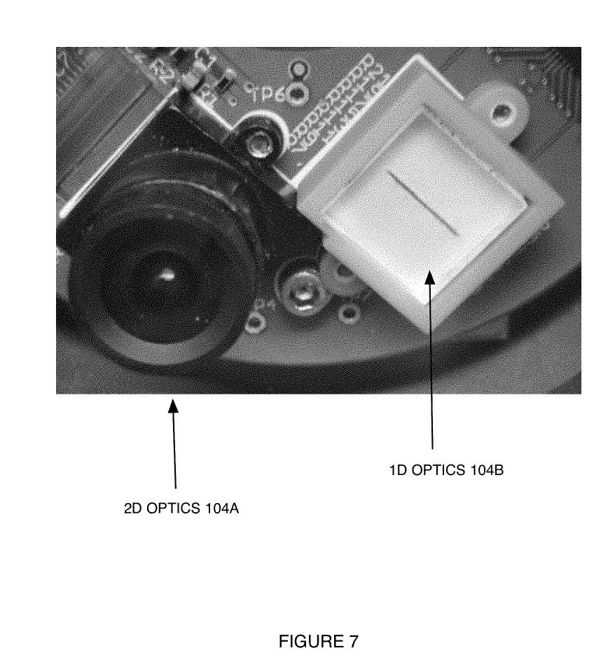

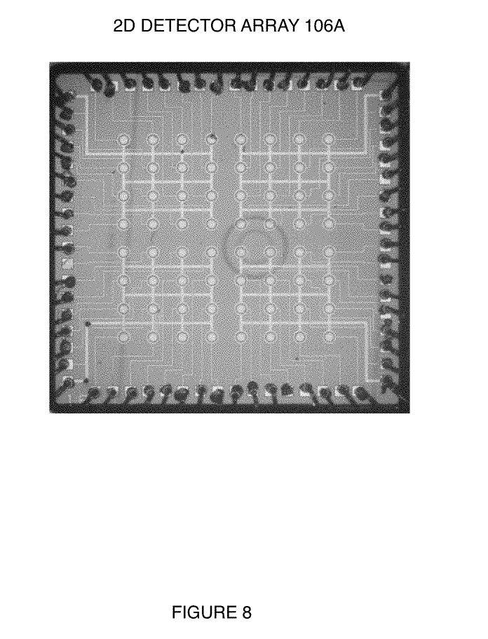

FIG. 7 is directed to a 2D optics and detector array, showing an image of exemplary optics that may be employed in the sensor 102. As shown, the optics 104 may comprise a Fresnel lens as optics 104A and a transmission grating as optics 104B. FIG. 8 shows an image of an exemplary 2D detector array.

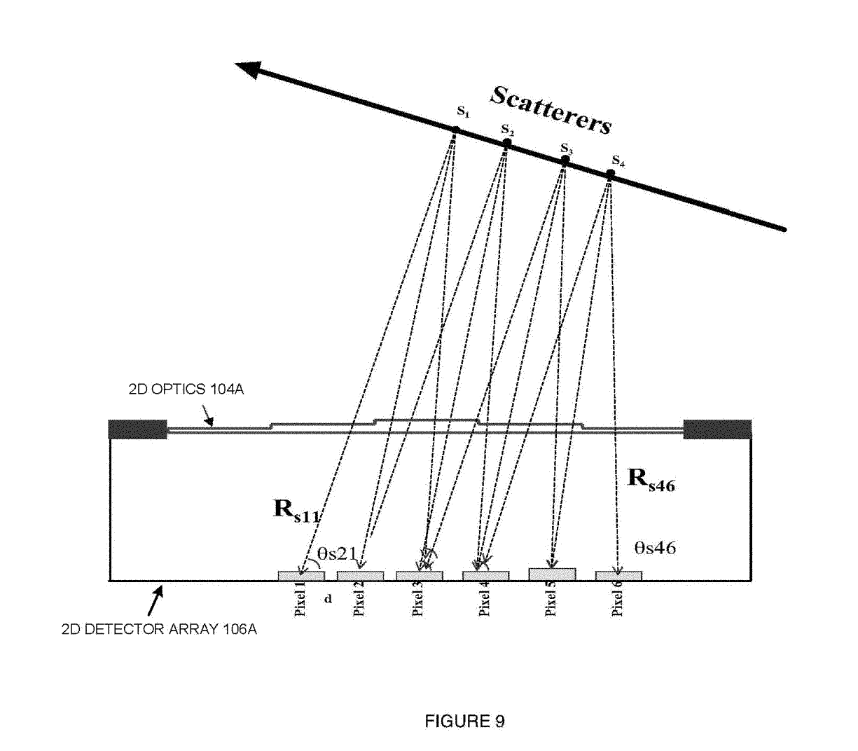

To understand the determination of angle of arrival of a laser emission, FIG. 9 conceptually illustrates how laser emissions and its angle of arrival are captured by the 2D detector array 106A of sensor 102. A threat laser or optical signal is incident on the LWR system 100 or is caused to be incident by atmospheric scattering on the aperture of the detector array 106A. The incident optical signal is transmitted through the Fresnel lens of 2D optics 104A on to the detector array 106A. Angular information is embedded in the detected optical and photocurrent signal. An angular discrimination algorithm is then used to determine the angle of arrival.

The angle of arrival can be determined from the relative intensity of all the pixels in the detector array 106A. The technique is based on the known non-coherent Fresnel finding technique. In particular, the Fresnel lens located at the aperture of detector array 106A causes the transmittance of the radiation to vary continuously as a function of the incident angle. The intensity at each pixel in the detector array 106A is thus a function of the angle of each pixel relative to the emission source, and the range and the resolution is a function of the relative intensity distribution over the image formed by the pixels in the detector array 106A.

The measured relative intensities at each pixel provide enough information for range determine using algorithms and by electronic signal processing of the pixel photocurrent data.

The angle of arrival (Theta) can be calculated using the angle dependent Fresnel transmission curves, which can be correlated to the photocurrent signals I generated by each pixel of the detector array using the following equations:

$${θ}_{1} = f [ \frac{{I}_{1}}{{I}_{1} + {I}_{2}} ] {θ}_{2} = f [ \frac{{I}_{2}}{{I}_{1} + {I}_{2}} ] θ = f [ \frac{{I}_{1} - {I}_{2}}{{I}_{1} + {I}_{2}} ]$$

In addition, the range of the origin or source of the laser to system 100 may be calculated based on the following equation:

$$R = \frac{d}{2 cos {θ}_{2}} [ \frac{{sin}^{2} {θ}_{2} - {sin}^{2} {θ}_{1}}{{sin}^{2} ( {θ}_{2} - {sin}^{2} {θ}_{1} )} ] - 1$$

Angular Determination Algorithm.

Various algorithms may be used for determining the incident angle of an optical signal, such as a laser emission. These non-linear equations can be solved using non-linear equation solvers that may be programmed into FPGAs or as a microprocessor firmware, or software as part of processor 110. In general, the angular recognition algorithm comprises: measuring photocurrents of pixels received by the sensor; calculating photocurrent ratios; solving the nonlinear equations to determine an angle of arrival of the optical signal; and using the angle of arrival to determine a distance of the optical signal.

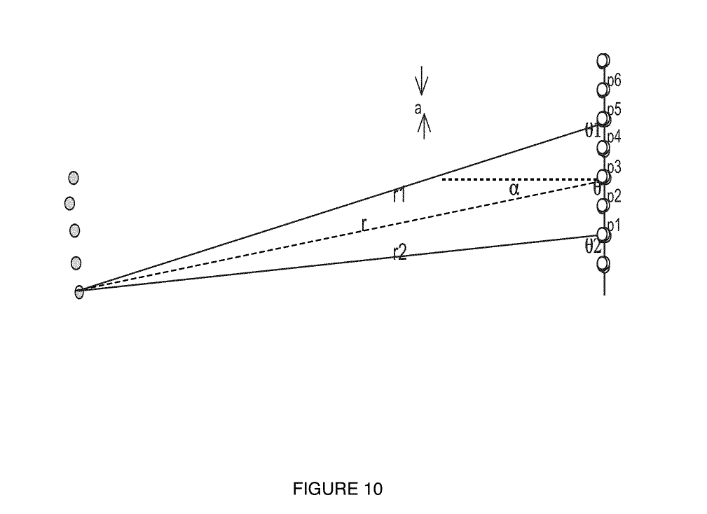

One example is described with reference to determining the angle and distance of an optical signal, such as a laser. As shown in FIG. 10, an LWR optical configuration for system 100 is illustrated. In FIG. 10, the dots represent the laser at different angular positions relative to the pixels, which are numbered p1 to p6, for example. The distance between the laser and the LWR at any arbitrary angular position, rᵢ, and the photocurrent at each pixel, iₚₕᵢ, can be expressed by the classical range equation and the Fresnel equation as follow:

$$\begin{matrix}{r}_{i} = \frac{a}{2} [ \frac{sin {θ}_{i}}{sin ( θ - {θ}_{i} )} ] = \sqrt{\frac{G}{{i}_{phi}}} {e}^{- β {r}_{i}} & 1 \\ {r}_{i} = \frac{a}{2 cos {θ}_{i + 1}} [ \frac{{sin}^{2} {θ}_{i + 1} - {sin}^{2} {θ}_{i}}{{sin}^{2} ( {θ}_{i + 1} - {sin}^{2} {θ}_{i} )} ] - 1 & 2 \\ {i}_{phi} = \frac{4 G}{{d}^{2}} [ \frac{{sin}^{2} ( θ - {θ}_{i} )}{{sin}^{2} θ} ] {e}^{- 2 β {r}_{i}} & 3\end{matrix}$$

In the above, θᵢ is the angle of incidence on pixel pᵢ, θ is the angle subtended between the source and the midpoint between pixels pᵢ and pᵢ₊₁. G is the constant in the range equation which accounts for the detector performance and other physical constants, d is the spacing between the pixels and b is the optical attenuation coefficient.

The intensity ratio at each pixel can then be expressed as:

$$\frac{{i}_{phi}}{{i}_{ph 1} + {i}_{ph 2} + … + {i}_{phi}} = \frac{[ \frac{{sin}^{2} ( θ - {θ}_{i} )}{{sin}^{2} θ} ]}{[ \frac{{sin}^{2} ( θ - {θ}_{1} )}{{sin}^{2} θ} ] + [ \frac{{sin}^{2} ( {θ}_{2} - θ )}{{sin}^{2} {θ}_{2}} ] + … + [ \frac{{sin}^{2} ( {θ}_{i} - θ )}{{sin}^{2} {θ}_{i}} ]} \qquad 4$$

Equation 4 can be used to generate i non-linear equations with i variables and the intensity ratios are based on the measured photocurrent data at each pixel. Any other type of non-linear equations can be formulated based on any functions or transform of the photocurrent data. The most obvious of these is the intensity ratio, which has the advantage of normalizing the data to eliminate systematic anomalies.

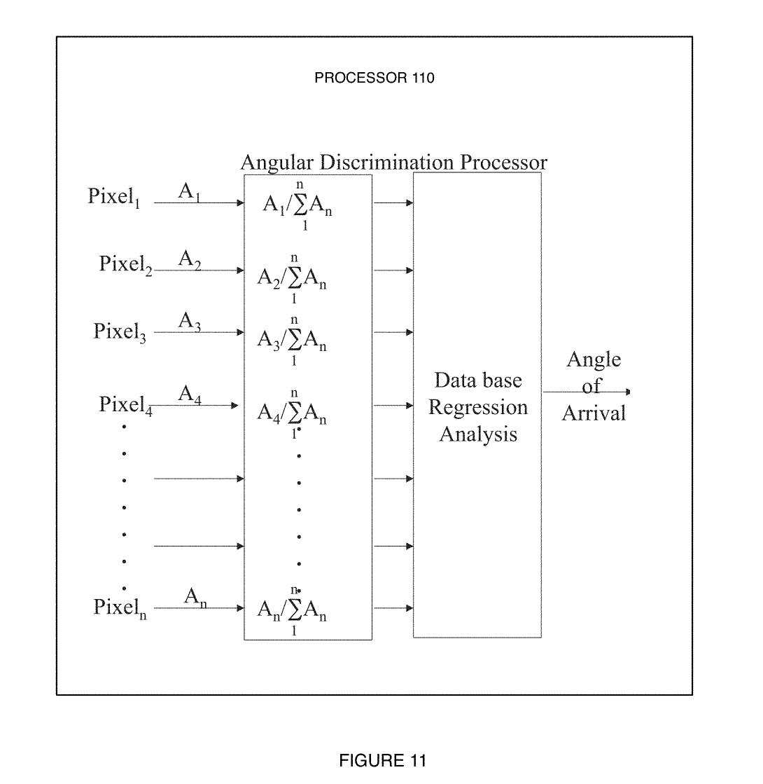

FIG. 11 shows one example of how data from the detector 106 may be processed to determine angular information of laser emissions in accordance with the principles of the present invention. As shown, the processor 110 may comprise an angular discrimination processor, which interprets the embedded angular information provided by the detector 106 104. In this embodiment, the processor 110 employs a database regression analysis to then determine the angle of arrival, for example, using a lookup table described below. The processor 110 may execute various routines and subroutines based on program code, such as VHDL, and C++ to perform the angle of arrival determination and range determination algorithms of the equations described above.

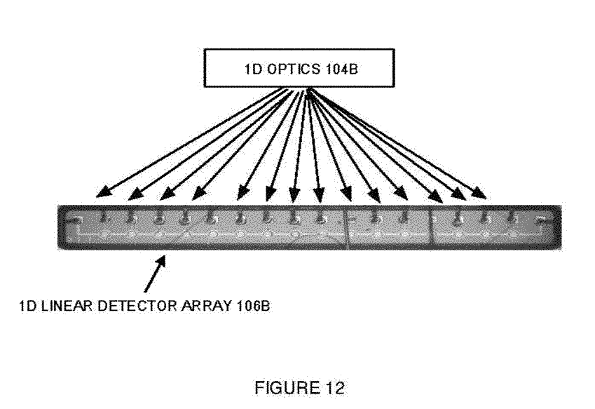

False Alarm Rejection. FIG. 12 shows exemplary 1D detector arrays that may be used in some embodiments. In one embodiment, the 1D detector array 106B may comprise a linear 1×16 array of APDs. The 1×16 linear arrays may be designed to detect and discriminate optical signal spectrally dispersed by transmission gratings for wavelength discrimination and false alarm rejection. A resistive load or an ROIC may be used to convert the optical currents of the 1×16 linear array to voltages and to send the 16 pixel data to the sensor interface 108 in parallel.

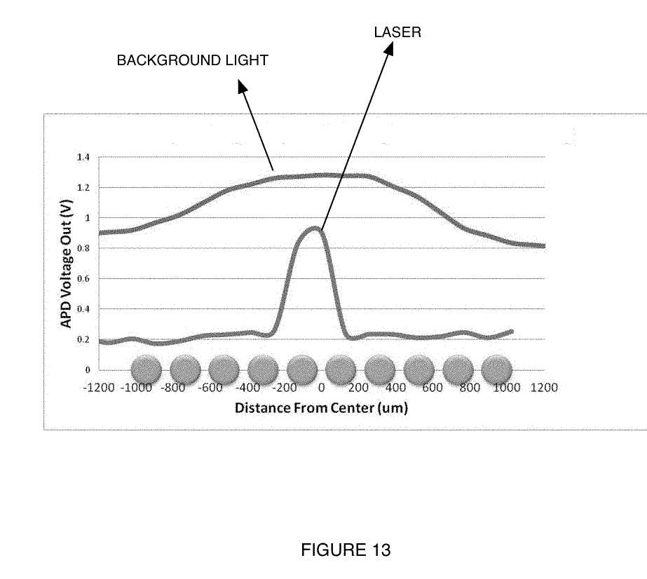

FIG. 13 conceptually illustrates how laser emissions are distinguished from other types of optical information by the 1D detector array 106B of the embodiments. In particular, the 1D detector array 106B may be used to avoid/minimize false alarms. The false alarm rejection is based on spectral discrimination, pulse repetition frequency (PRF), pulse-width and threshold

As shown, the 1D detector array 106B receives an optical signal from 1D optics 104B, which may be configured as a transmission grating and cylindrical lens focused. As shown, the incoming threat optical signal passes through the grating, which disperses the photons spatially depending on their wavelength. Lasers operating at a single wavelength will only illuminate a small area of the 1D detector array 106B and will therefore be incident at a predetermined pixel depending on the optical design. Broadband light sources, however, have a continuum of wavelengths and thus will be split into individual wavelengths and illuminate many pixels. Using the pixel distribution of photocurrent on the linear array, the LWR electronics of system 100 can determine if the optical signal is coming from a narrowband source and at what wavelength.

The normalization of the output signals allows the range measurement to be independent of the signal level from the target. Therefore, by measuring the photocurrents of the detector array pixels the angles can be calculated.

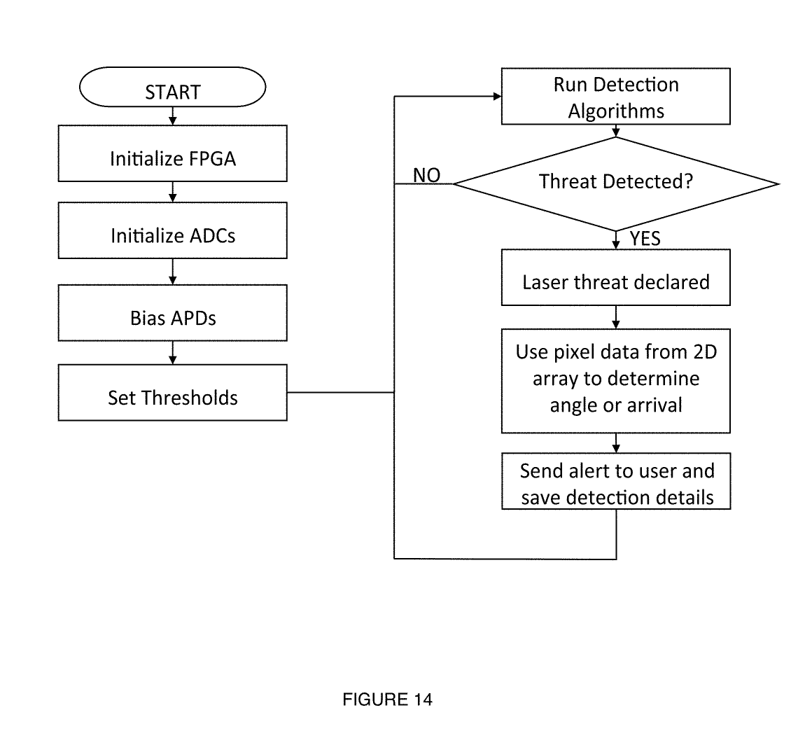

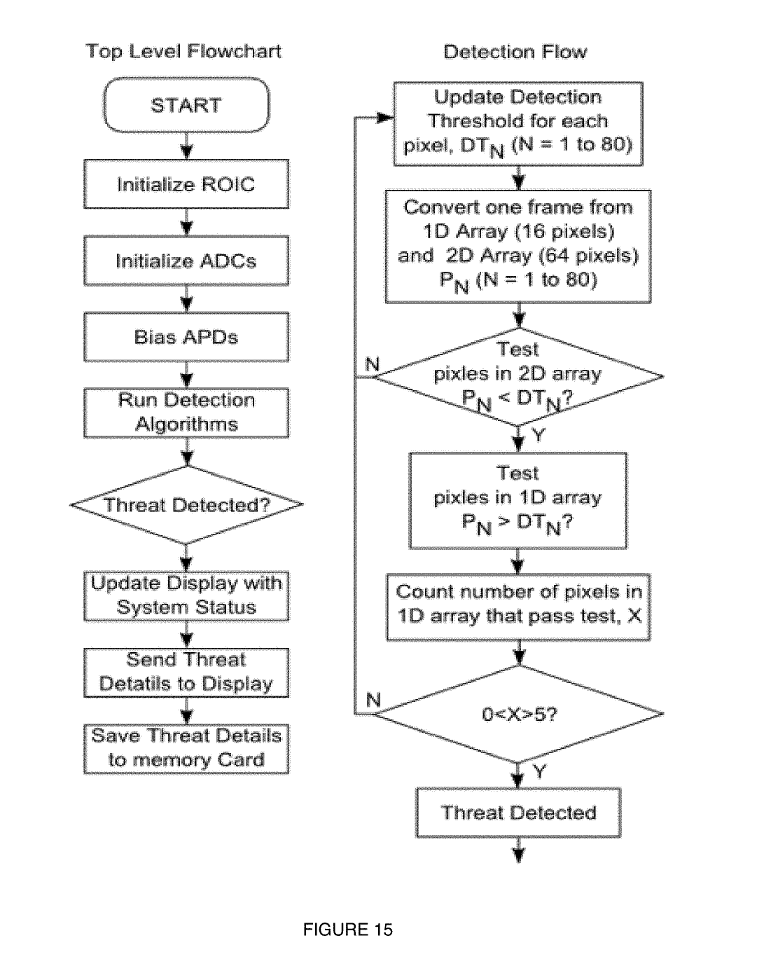

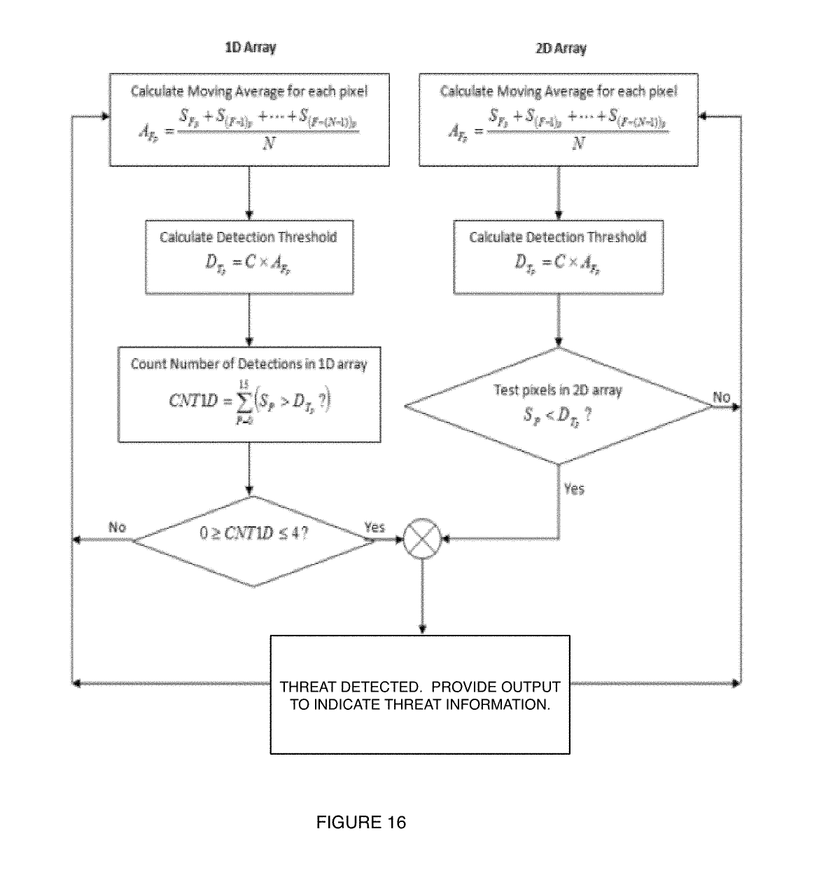

Exemplary Software Process Flows. FIG. 14 shows an exemplary general process flow for the software behind Applicant's system in the '607 application. FIG. 15 shows another software process flow, and FIG. 16 shows a software process flow for detection of laser emissions. These process flows may be implemented as software using known executable program code language, such as VHDL, C, C++. Those skilled in the art will recognize that any programming language and program code using any number of subroutines, libraries, etc. may be employed in the embodiments. In another embodiment, the spectral signature of the optical signal may be determined. The spectral discrimination feature may be implemented using filters provided at each of the pixels. For example, semiconducting optical amplifiers, such as fabry-perot filters, may be implemented. Any type of filter may be implemented using known techniques.

Alternatively, spectral discrimination may be accomplished using a grating to spatially disperse the optical signal onto an array of pixels designed to correspond to different wavelengths. These spectral discrimination features enable false alarm rejection, threat identification, classification, as well as spectral binning to reduce false alarms and enable the capability for day/night operation.

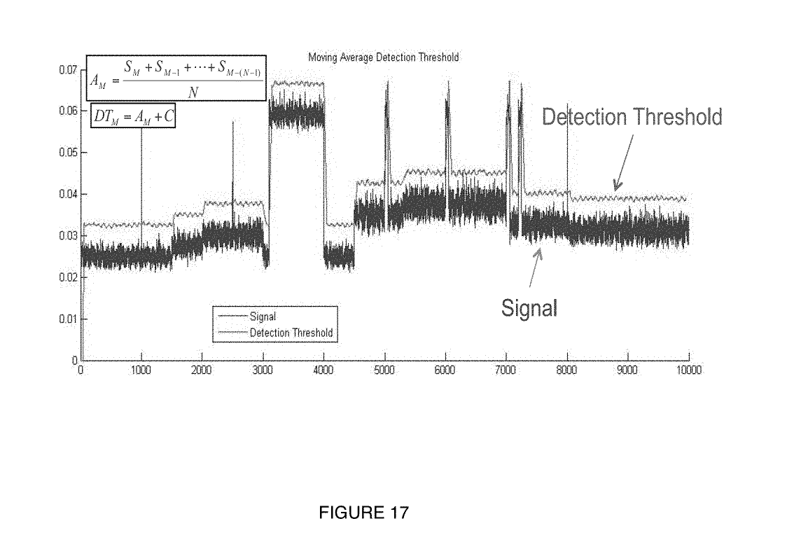

Detection Threshold. FIG. 17 illustrates how the system 100 sets a detection threshold. The detection threshold analysis is based on concepts and formulas used to characterize bit error rate (BER) in communications, which is equivalent to the false alarm rate (FAR) in detection theory. The FAR is related to the sensitivity, which may be expressed by the following equations:

Sₘᵢₙ=Q*NEP

FAR=1/2[1−erf(Q/√2)]˜1/√(2p)[exp((−Q²/2))/Q] 3.2.2

FAR˜NEP/√(2p)[exp((−(Sₘᵢₙ/NEP)²/2))/Sₘᵢₙ,] 3.2.3

In the above, NEP is the noise equivalent power at which the signal-to-noise ratio (SNR) is 1, Q is the error or false alarm factor which is related to FAR by an error function for generalized noise or a Gaussian function for Gaussian noise. While NEP is the minimum noise power (sensitivity) at SNR=1, Sₘᵢₙ is the sensitivity at an SNR designed to produce a particular FAR. These equations were used to estimate the trade-off between FAR and sensitivity. For these estimates, the threshold may be set to yield a probability of detection close to 100%.

Applicant's LWR sensor system 100 having been described in detail, the example embodiments are now directed to an automotive collision avoidance system and method that can be fabricated at lower cost, uses lower power in both normal and obscured conditions, is much less computationally intensive, and much more sensitive to thereby provide 360 degree coverage with greater accuracy then current solutions.

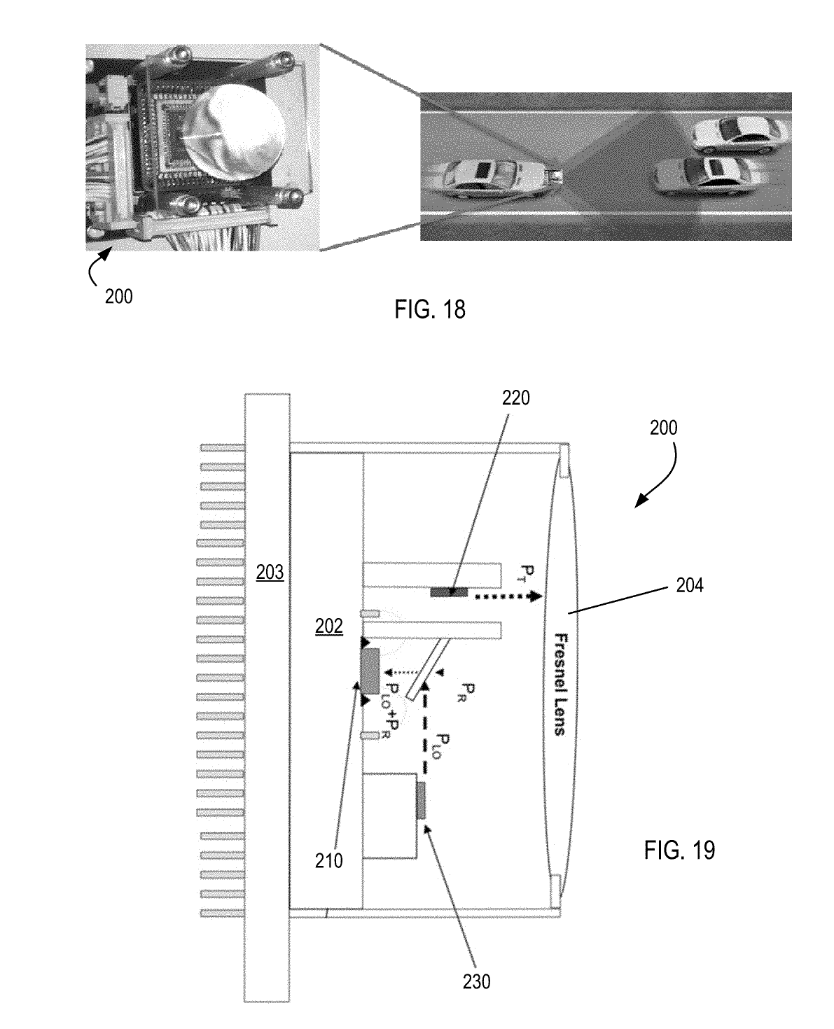

Referring to FIG. 18, in general, there is shown an automotive collision avoidance sensor system 200 (“sensor system 200”) for that has a LWR sensor therein (similar to as described in FIGS. 1-17) configured to detect the smallest quanta of light from reflecting surfaces of cars, moving objects and the like. Although shown in FIG. 18 in an application for automotive collision avoidance, this example sensor system 200 is equally applicable to robotics, obstacle warning systems, lane change assist systems, autonomous vehicle systems, traffic cop warning devices for automobile drivers, and the like.

In an example, the sensor system 200 is mounted in both the fore and aft of the vehicle (generally along the line of sight of the driver in the front grill and rear bumper, as an example), and is capable of detecting scattered laser signals from the nearby vehicles Similar to LWR system in FIGS. 1-17 sensor system 200 has integral signal processing algorithms and software to determine the distance, angle, speed and bearing of nearby vehicles. If a collision event is imminent, the sensor system 200 alerts the driver or through a commend signal to installed vehicle safety software applies corrective actions such as braking and/or adjustment of steering to avoid the accident.

FIG. 19 is a block diagram of the sensor system 200. In general, the sensor system includes optics 204 (which may include both an input lens for reception and an output lens for transmission), a collision avoidance laser warning sensor 210 (hereafter “CA sensor 210”), a transmit laser 220 and an optional local oscillator (LO) laser 230 for coherent sensing and greater sensitivity. The CA sensor 210 has a minimum detectable intensity of 10 nanowatts per square centimeter and is essentially the LWR sensor of the co-pending '607 application, but as it is employed with a transmitting laser, it can be referred to as an active laser sensor. CA sensor 210 and the lasers 220, 230 are affixed to a printed circuit board 202 which is electrically connected via connector 203 to vehicle power and other on-board electronics.

Optics 204 may be an optical package that comprises one Fresnel lens for the input and another for the output lens of optics 204, with or without an optical grating. In another example, optics 204 may be an optical package that comprises a doublet Fresnel lens (I/O lenses) and also for 2D angle resolving detection (EFL 2.5 mm, FOV)>100° and a transmission grating and cylindrical lens (FL 5 mm, FOV)>100° focused on a one-dimensional linear array (1D array) for optical false alarm rejection. Optics 204 could be a combination lens setup with transmitter lens on the output side and Fresnel on the receive/input side.

As previously described with the LWR sensor 102, CA sensor 210 is adapted to collect the incident optical signal, and includes a detector array of photodetectors (as was described for detector 106 in FIGS. 1-17) having a pixel pitch from about 150 μm to 210 μm enabling an angular coverage of up to 360°. The detector array converts the collected incident optical signal(s) into a photocurrent for output from the CA sensor 210, via a sensor interface (such as a ROIC) coupled to the sensor to convert the photocurrent into output voltages and signals for analysis by an enhanced data processor coupled to the sensor interface. The basic block diagram of FIG. 1 is thus applicable here as well, although the processor in this embodiment is an enhanced data processor that calculates ranging information (distance, azimuth, and elevation), 3D rendering, issues warning and alarms and performs automated collision avoidance in driverless mode).

In one specific configuration, and similar to as specified for LWR 102 above, the optics 204 may be embodied as a doublet Fresnel lens, and the detector array may be a two dimensional (2D) detector array of avalanche photodiodes (APDs) coupled to the Fresnel lens to convert the optical signal into a photocurrent. Output voltages and signals converted from the 2D detector array photocurrent by the sensor interface are employed with Fresnel equations in algorithms iterated by the processor to determine the range, azimuth, elevation). In an example, the 2D detector array may have a breakdown voltage of 35 volts, a dark current of less than 100 nA, and an optical gain between 10-15 A/W.

Further, and similar to as specified for LWR 102 above, here the CA sensor 210 may further includes a transmission grating with cylindrical lens attached thereto, and a linear (1D) detector array coupled to the grating and to the cylindrical lens, the incident optical signal passing through the grating, which disperses photons thereof spatially depending on wavelength, the photons collected by the cylindrical lens and directed to the 1D detector array for conversion into photocurrents, the output voltages and signals converted therefrom by the sensor interface analyzed spectrally by the processor

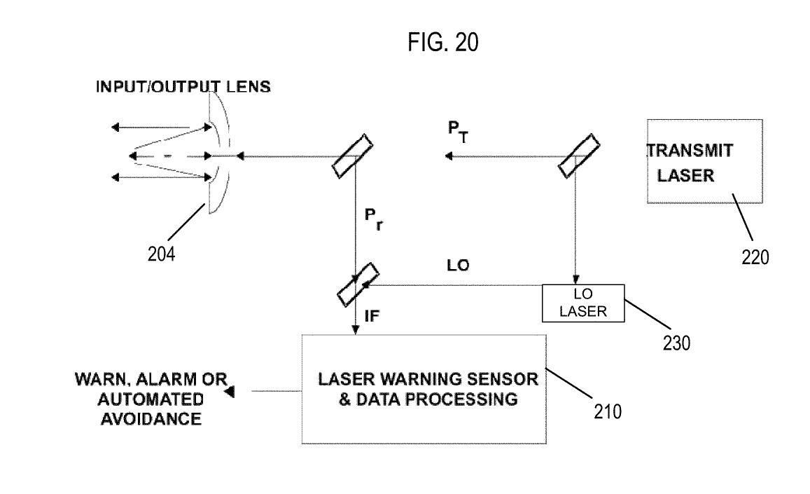

FIG. 20 is a general electro-optical flow diagram to explain functionality of the sensor system 200 in some more detail. The laser transmitter 220 in an example may be a 1.55-um DFB laser with less than 1 Watt output, either as a pulsed laser or CW laser modulated to form 0.01-1-microsecond pulses. The transmit beam is then split to form the output beam (P_{T}) and the local oscillator beam (LO). The return signal from the roadway, surrounding vehicles or objects, (Pᵣ) is mixed with the LO signal to generate the IF signal which is then received by the CA sensor 210 for processing and analysis via its sensor interface and data processor. In a different embodiment, the return signal (Pᵣ) is not mixed with the LO, but is directly detected by the CA sensor 210. The input/output lenses for optics 204 could either be an integral lens such as a Fresnel, or two separate lenses as described above.

Sensor system 200 is designed to provide 3D situation awareness. Namely, the CA sensor 210 with its associated data processor is adapted to determine each of the range R, azimuth angle θ_{az} and elevation angle θₑₗₑ of vehicle surroundings. In other words, information as to the proximity of objects fore, aft, starboard and port are constantly measured and updated. CA sensor 210 with its associated data processor then builds a point cloud of vehicle surroundings from the R, θ_{az} and θₑₗₑ data, and then builds a 3D model of vehicle surroundings from the point clouds. This 3D model will be similar to, but more precise than what a human driver would see if he/she had 180° field-of-view (FOV). The CA sensor 210 then constructs a safe zone (such as a safe breaking distance zone) in the 3D model and generates alarms or takes evasive actions for any intrusion into the safe zone.

The sensor system 200 is foreseen in various operational scenarios. In one example, system 200 may include a vehicle cutting-in warning/braking system command setup; in another, a vehicle ahead sudden braking warning/braking system command setup. Sensor system 200 may also provide a side-swipe avoidance system function to the driver or car.

The sensor system 200 employs an active CA laser sensor 210, operating in wavelengths of near-uv, or blue (350-450 nm) to penetrate fog and enhance sensitivity in obscured conditions. As the transmit laser 220 emits a pulsed beam, a high frame rate is not needed.

Accordingly, the automotive collision avoidance sensor system 200 described herein provides 3-dimensional situation awareness measurements, namely real-time distance, azimuth and elevation angles of objects. Sensor system 200 offers automobiles the same 3D situation awareness capabilities as humans. The proximity of objects fore, aft, starboard & port are constantly measured and updated. Safe breaking distance may be constantly measured and updated, and an imminent collision warning may be issued for proximity less than the safe breaking distance, or outside the safe zone.

The example embodiments having been described, it is apparent that such have many varied applications. For example, the example embodiments may be applicable but not limited to connection to various devices, structures and articles.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. An automotive collision avoidance sensor system installed at both the fore and aft of a vehicle, comprising:
an output lens and an input lens,
a transmit laser adapted to transmit a pulsed beam through the output lens to impact roadway, surrounding vehicles or objects fore, aft, port and starboard of the vehicle, with return signals from the roadway, surrounding vehicles or objects reflecting off the input lens, and
a sensor adapted to collect the return signals from the input lens to convert them into output voltages and signals, the sensor including a data processor configured to analyze the output voltages and signals so as to calculate real-time 3-dimensional situation awareness measurements and safety metrics which are constantly measured and updated to prevent possible collision.

2. The system of claim 1, wherein the three-dimensional situation awareness measurements are real-time distance, azimuth and elevation angles of the objects.

3. The system of claim 1, wherein the constantly measured and updated safety metrics include a safe breaking distance or safe zone calculation.

4. The system of claim 1, wherein the sensor includes a detector array of photodetectors adapted to convert the collected return signals into a photocurrent having a pixel pitch from about 150 μm to 210 μm enabling an angular coverage of up to 360.

5. The system of claim 1, further comprising:
a local oscillator (LO) laser for coherent sensing and greater sensitivity, the beam from the LO laser mixing with the return signals to form an IF signal collected by the sensor.

6. The system of claim 1, wherein the transmit laser has less than 1 Watt output and its beam modulated to form 0.01-1-microsecond pulses.

7. The system of claim 1, wherein the sensor further includes:
a two dimensional (2D) detector array of avalanche photodiodes (APDs) which are coupled to the input lens to convert the return signals into a photocurrent, the 2D detector array having a breakdown voltage of 35 volts, a dark current of less than 100 nA, and an optical gain between 10-15 A/W.

8. The system of claim 1, wherein the sensor has a minimum detectable intensity of 10 nanowatts per square centimeter.

9. The system of claim 1, wherein the sensor operates in wavelengths of near-uv or blue (350-450 nm) to penetrate fog and enhance sensitivity in obscured conditions.
